(19) United States
(12) Patent Application Publication
(10) Pub. No.: US 2011/0242148 A1
(43) Pub. Date: Oct. 6, 2011

(54) COLOR DISPLAY DEVICE

(76) Inventors: Keiichi Ina, Osaka (JP); Keisuke Yoshida, Osaka (JP); Takuya Tsuda, Osaka (JP)

(21) Appl. No.: 13/133,069

(22) PCT Filed: Sep. 16, 2009
(86) PCT No.: PCT/JP2009/066122

§ 371 Date: Jun. 6, 2011

(30) Foreign Application Priority Data
Jan. 9, 2009 (JP) 2009-003063

(51) Int. Cl. G09G 3/36; G09G 5/02

(52) U.S. Cl. 345/690; 345/88

(57) ABSTRACT

In a display device of the present invention, a total fluctuation calculation portion (23) included in a display control circuit (200) calculates total amounts of potential fluctuations of drive video signals to be applied to video signal lines during one frame period based on external display data signals (DATs). For a pixel formation portion to be provided with a display data signal (DATₚ) (corresponding to the next display row of the previous frame) received from frame memory (22), a data correction portion (24) performs correction to compensate for impact to be caused by potential fluctuations of an opposite video signal line adjacent but not connected to the pixel formation portion. As a result, the instant delta-arrangement color display device allows horizontal streaks, which are caused by potential fluctuations of opposite video signal lines as mentioned above, to be reduced or eliminated using a simplified configuration.

### TECHNICAL FIELD

The present invention relates to color display devices, and more specifically to an active-matrix color liquid crystal display device with pixels in a so-called delta arrangement.

### BACKGROUND ART

In general, display portions of conventional active-matrix liquid crystal display devices include a plurality (N) of scanning signal lines GL₍₁₎to GL_{(N)}, a plurality (M) of video signal lines SL₍₁₎to SL_{(M)} crossing the scanning signal lines, and a plurality (N×M) of pixel formation portions P_{(1,1)} to P_{(N,M)} arranged in a matrix so as to correspond to their respective intersections of the scanning signal lines and the video signal lines, each pixel formation portion including liquid crystal capacitance (also referred to as “pixel capacitance”) Clc formed by a pixel electrode and an electrode opposing thereto, as shown in FIG. 2 to be described later. Each pixel electrode has two video signal lines SL₍ₘ₎ and SL₍ₘ₊₁₎ provided so as to sandwich the electrode therebetween, and parasitic capacitance is present between each of the two video signal lines and the pixel electrode. The video signal line SL₍ₘ₎, one of the two video signal lines, is connected to the pixel electrode via a TFT 10.

Hereinafter, the parasitic capacitance formed between the pixel electrode and the video signal line (referred to below as the “self-source line”) SL₍ₘ₎ connected thereto is denoted by reference characters “Csₐ”, and the parasitic capacitance formed between the pixel electrode and the other (referred to below as the “other-source line”) SL₍ₘ₊₁₎ of the two video signal lines is denoted by reference characters “Cs_{b}”.

For each pixel formation portion P_{(n,m)} in such an active-matrix liquid crystal display device as described above, when the TFT 10 connected to the pixel electrode is in on state (conductive state), voltage is applied through the self-source line SL₍ₘ₎ to the TFT 10, and when the TFT 10 is brought into off state (closed state), the applied voltage is held in the pixel capacitance Clc until the next time the TFT 10 is brought into conductive state, so that pixel display is performed in accordance with the voltage being held (n=1, 2, . . . , N; m=1, 2, . . . , M). However, the pixel electrode for forming the pixel capacitance Clc is connected to the self-source line SL₍ₘ₎ via the parasitic capacitance Csₐ and is also connected to the other-source line SL₍ₘ₊₁₎ via the parasitic capacitance Cs_{b}. Accordingly, while the TFT 10 connected to the pixel electrode is in closed state, the potential of the pixel electrode (the voltage being held in the pixel capacitance) is affected by potential fluctuations of the self-source line SL₍ₘ₎ via the parasitic capacitance Csₐ, and is also affected by potential fluctuations of the other-source line SL₍ₘ₎ via the parasitic capacitance Cs_{b}. Due to the potentials of the video signal lines SL₍ₘ₎ and SL₍ₘ₊₁₎ affecting the potential of the pixel electrode and the voltage being held in the pixel capacitance Clc in such a manner, a phenomenon (referred to as “crosstalk”) occurs in which the amount of light transmitted through the liquid crystal fluctuates, making it impossible to achieve a desired tone. Also, in the case of color liquid crystal display devices for displaying color images, there are groups of three pixel formation portions for forming R(red), G(green) and B(blue) pixels as color image display units arranged side by side in a direction in which the scanning signal line extends, and if the impact of crosstalk on the potential of the pixel electrode varies (in terms of degree and/or direction) among the three pixel formation portions corresponding to their respective display units, a phenomenon (referred to as “color crosstalk”) occurs in which a desired color display cannot be provided.

Also, as shown in FIG. 3, groups of (pixel formation portions forming) three (vertically or horizontally) adjacent pixels, red (R), green (G) and blue (B), are disposed such that all internal angles of each triangle formed by connecting the pixels center to center are acute angles, and such a pixel arrangement is called a delta arrangement. Since even such delta-arrangement color liquid crystal display devices have the aforementioned crosstalk problems, there are provided some conventional delta-arrangement color liquid crystal display devices, including those with reduced parasitic capacitance Cs_{b} in which the other-source lines are located away from the pixel electrodes to reduce the parasitic capacitance, thereby eliminating or suppressing such crosstalk, and those with the parasitic capacitance Cs_{b} being approximately equalized among red (R), green (G) and blue (B) pixel formation portions in which additional parasitic capacitance is suitably provided between the other-source lines and the pixel electrodes corresponding to their respective pixel formation portions, thereby eliminating or suppressing color crosstalk (see Japanese Laid-Open Patent Publication No. 2000-10123).

### CITATION LIST

### Patent Document

[Patent Document 1] Japanese Laid-Open Patent Publication No. 2000-10123

### SUMMARY OF THE INVENTION

### Problems to be Solved by the Invention

However, any attempt to suppress or eliminate the impact of crosstalk using any of the aforementioned conventional and characteristic structures results in increased production cost due to formation of such a structure. In addition, the delta-arrangement color liquid crystal display device as described especially in Japanese Laid-Open Patent Publication No. 2000-10123 requires an additional wiring area for adding parasitic capacitance, resulting in a problem where an aperture ratio is reduced due to the wiring area.

Furthermore, unlike general matrix-arrangement color display devices, delta-arrangement color display devices are not configured such that any video signal line connected to pixel formation portions for displaying the same color is always a specific one of two video signal lines adjacent to the right and left of the pixel formation portions (i.e., the side changes between even and odd display rows). Therefore, the aforementioned conventional color crosstalk solution based on the premise that the self- and other-source lines are always the one and the other of the two horizontally adjacent video signal lines cannot be similarly applied to delta-arrangement color display devices.

Also, in the case of delta-arrangement color display devices, because of the aforementioned structure, the impact of potential fluctuations via parasitic capacitance on the pixel formation portions for forming the same color varies between even and odd display rows. Therefore, unlike in the conventional case of color crosstalk, the impact of potential fluctuations appears on delta-arrangement color display devices as horizontal streaks due to the degree of display color deviation (from a desired color) being different among rows.

Therefore, an objective of the present invention is to provide a delta-arrangement color display device which allows the impact of potential fluctuations via parasitic capacitance to be reduced or eliminated using a simplified configuration without forming any characteristic structure.

### Solution to the Problems

A first aspect of the present invention is directed to a color display device comprising a plurality of video signal lines for transmitting a plurality of video signals corresponding to image signals provided from outside the device for displaying a color image, a plurality of scanning signal lines crossing the video signal lines, a plurality of types of pixel formation portions arranged along the video signal lines and the scanning signal lines for displaying different primary colors, and a drive control circuit for driving the video signal lines and the scanning signal lines, wherein,

the pixel formation portions are disposed in delta arrangement such that the plurality of types are adjacent to each other, and

the drive control circuit corrects a video signal to be provided to any pixel formation portion so as to compensate for impact by potential fluctuations of an opposite video signal line that are caused via parasitic capacitance between the opposite video signal line and said any pixel formation portion, the opposite video signal line being a video signal line adjacent but not connected to said any pixel formation portion.

In a second aspect of the present invention, based on the first aspect of the invention, the drive control circuit corrects the video signal to be provided to said any pixel formation portion, so as to compensate for only the impact of potential fluctuations of the opposite video signal line.

In a third aspect of the present invention, based on the first aspect of the invention, the drive control circuit calculates a value indicating impact by potential fluctuations of the opposite video signal line that are caused during approximately one frame period between a time point immediately after said any pixel formation portion was caused to transition from selected to deselected state by driving a scanning signal line corresponding thereto and a time point immediately before the next selected state, and the drive control circuit corrects the video signal based on the calculated value.

In a fourth aspect of the present invention, based on the third aspect of the invention, the drive control circuit includes:

a memory for storing values indicating pixel display tones included in the image signals for at least one frame period;

a total fluctuation calculation portion for calculating a total amount of potential fluctuations based on the values stored in the memory or the image signals as a value indicating the impact by the potential fluctuations; and

a data correction portion for correcting a value stored in the memory that indicates a corresponding pixel display tone based on a value obtained by multiplying the total amount calculated by the total fluctuation calculation portion by a predetermined coefficient in accordance with the parasitic capacitance.

In a fifth aspect of the present invention, based on any one of the first to fourth aspects of the invention, the pixel formation portions each include:

a switching element to be brought into a conductive or closed state in accordance with a signal applied to a scanning signal line connected to the pixel formation portion;

a pixel electrode connected via the switching element to a video signal line connected to the pixel formation portion and having the parasitic capacitance between the pixel electrode and the opposite video signal line;

a common electrode commonly provided for the pixel formation portions;

pixel capacitance formed by the pixel electrode and the common electrode; and

a liquid crystal element for displaying a pixel in a display tone in accordance with a voltage being held in the pixel capacitance.

### Effect of the Invention

According to the first aspect of the present invention, the drive control circuit in the delta-arrangement color display device corrects a video signal to be provided to any pixel formation portion so as to compensate for impact by potential fluctuations of an opposite video signal line that are caused via parasitic capacitance between the opposite video signal line and said any pixel formation portion, and therefore it is possible to reduce or eliminate horizontal streaks which occur due to the impact of potential fluctuations via parasitic capacitance as mentioned above, using a simplified configuration without forming any characteristic structure.

According to the second aspect of the present invention, the drive control circuit compensates for only the impact of potential fluctuations of an opposite video signal line, and therefore it is not necessary to consider any impact by potential fluctuations of a self-video signal line, which is a video signal line adjacent and connected to a pixel formation portion, so that horizontal streaks can be reduced or eliminated using a further simplified configuration.

According to the third aspect of the present invention, the drive control circuit calculates a value indicating impact by potential fluctuations of an opposite video signal line that are caused during approximately one frame period between a time point immediately after any pixel formation portion was caused to transition from selected to deselected state and a time point immediately before the next selected state, and therefore it is possible to perform accurate correction, thereby making it possible to reliably reduce or eliminate horizontal streaks to be caused by the impact.

According to the fourth aspect of the present invention, the memory for storing values indicating pixel display tones for at least one frame period, the total fluctuation calculation portion, and the data correction portion make it possible to reduce or eliminate horizontal streaks using a simplified configuration.

According to the fifth aspect of the present invention, it is possible to reduce the aforementioned impact by potential fluctuations via parasitic capacitance in any active-matrix color liquid crystal display devices using liquid crystal elements.

### BRIEF DESCRIPTION OF THE DRAWINGS

FIG. 1 is a block diagram illustrating the overall configuration of an active-matrix liquid crystal display device according to an embodiment of the present invention.

FIG. 2 is a circuit diagram illustrating an equivalent circuit for a pixel formation portion in the embodiment.

FIG. 3 is a diagram schematically illustrating a detailed configuration of a display portion in the embodiment.

FIG. 4 is a block diagram illustrating the configuration of a display control circuit in the embodiment.

### MODE FOR CARRYING OUT THE INVENTION

Hereinafter, an embodiment of the present invention will be described with reference to the accompanying drawings.

<1. Overall Configuration And Operation Of The Liquid Crystal Display Device>

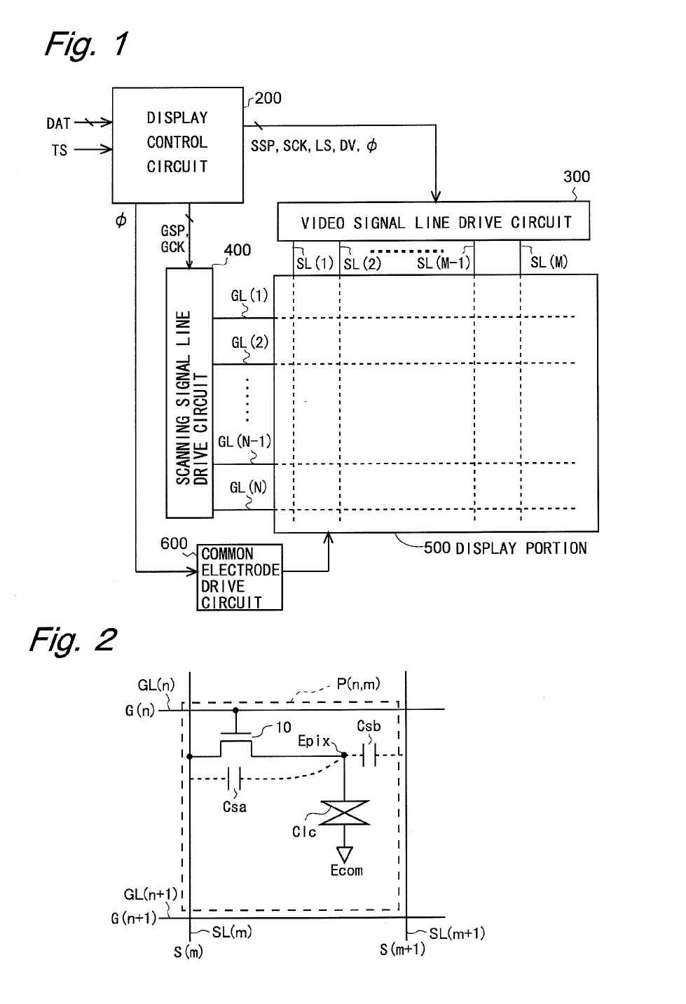

FIG. 1 is a block diagram illustrating the overall configuration of an active-matrix liquid crystal display device according to an embodiment of the present invention. The liquid crystal display device includes a drive control portion, which consists of a display control circuit 200, a video signal line drive circuit (source driver) 300 and a scanning signal line drive circuit (gate driver) 400, and also includes a display portion 500. The display portion 500 includes a plurality (M) of video signal lines SL₍₁₎ to SL_{(M)}, a plurality (N) of scanning signal lines GL₍₁₎ to GL_{(N)}, and a plurality (M×N) of pixel formation portions provided along the video signal lines SL₍₁₎ to SL_{(M)} and the scanning signal lines GL₍₁₎to GL_{(N)} Note that in the following, pixel formation portions provided in association with and in proximity to (in the figure, proximal to the right of and below) their respective intersections of the scanning signal lines GL₍ₙ₎ and the video signal lines SL₍ₘ₎ are denoted by reference characters “P_{(n,m)}”. FIG. 2 illustrates an equivalent circuit for the pixel formation portion P_{(n,m)} in the display portion 500 of the present embodiment.

However, the pixel formation portions P_{(n,m)} in the present embodiment are provided in a delta arrangement different from that of pixel formation portions as provided in display portions of typical active-matrix liquid crystal display devices, such that not all of the pixel formation portions P_{(n,m)} are connected to their respective video signal lines SL₍ₘ₎ passing on the left side of pixel electrodes, but some of them are connected to video signal lines SL_{(m+1).}

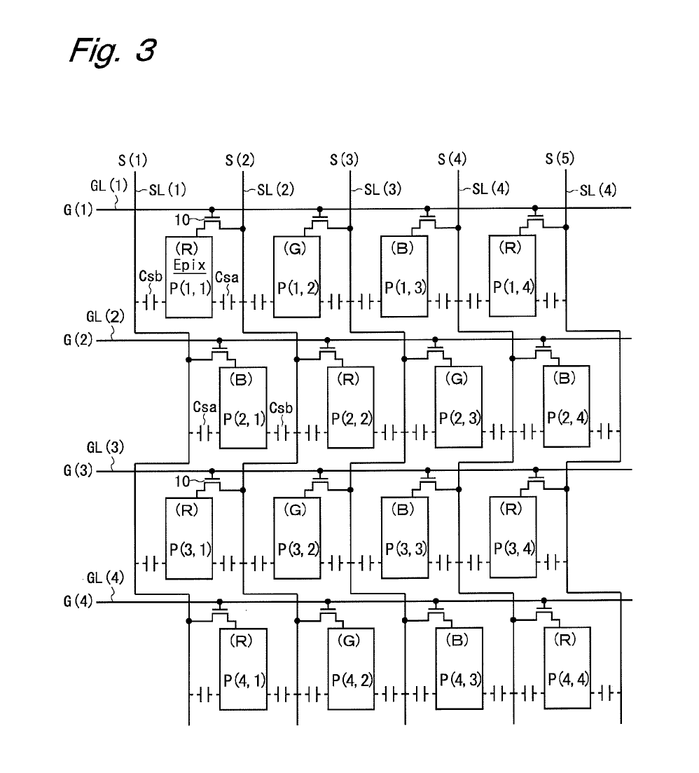

FIG. 3 illustrates a detailed configuration of the display portion 500 in the present embodiment, including the relation of connections as described above. As shown in FIGS. 2 and 3, each pixel formation portion P₍ₘₘ₎ includes a TFT 10, which is a switching element having a gate terminal connected to the scanning signal line GL₍ₙ₎ and a source terminal connected to the video signal line SL₍ₘ₎ passing the intersection or the video signal line SL₍ₘ₊₁₎ adjacent thereto; a pixel electrode Eₚᵢₓ connected to a drain terminal of the TFT 10; a common electrode E_{com} commonly provided for the pixel formation portions P_{(i,j)}(i=1 to N, j=1 to M); and a liquid crystal layer commonly provided for the pixel formation portions P_{(i,j)} (i=1 to N, j=1 to M) between the pixel electrode Eₚᵢₓ and the common electrode E_{com}.

Each pixel formation portion P_{(n,m)} has liquid crystal capacitance (also referred to as “pixel capacitance”) Clc formed by the pixel electrode Eₚᵢₓ and the common electrode E_{com} opposing thereto with respect to the liquid crystal layer. Each pixel electrode Eₚᵢₓ has two video signal lines SLₘ) and SL₍ₘ₊₁₎ provided so as to sandwich the pixel electrode therebetween, and one of the two video signal lines is connected to the pixel electrode Eₚᵢₓ via the TFT 10. For example, the video signal line that is connected to the pixel formation portion P_{(1,1)} of the display portion 500 shown in FIG. 3 is the video signal line SL₍₂₎, and the video signal line that is connected to the pixel formation portion P_{(1,2)} neighboring on the right is the video signal line SL₍₂₎. Also, the video signal line that is connected to the pixel formation portion P_{(2,1)} is the video signal line SL₍₁₎, and the video signal line that is connected to the pixel formation portion P_{(2,2)} neighboring on the right is the video signal line SL₍₂₎. In this manner, the self-source line, which is a video signal line connected to a pixel electrode of a pixel formation portion of interest, is the video signal line SL₍ₘ₊₁₎ when the number n corresponding to a display row is odd or the video signal line SL₍ₘ₎ when the number n is even.

Also, parasitic capacitance Csₐ is present between the pixel electrode Eₚᵢₓ and the aforementioned self-source line, one of the two video signal lines having the pixel electrode Eₚᵢₓ sandwiched therebetween, and parasitic capacitance Cs_{b} is present between the pixel electrode Eₚᵢₓ and the aforementioned other-source line, the other of the two video signal lines.

In addition, the pixel formation portions P_{(n,m)} display red (R), green (G) or blue (B), and are arranged in the order R, G, B in directions along the scanning signal lines GL₍₁₎ to GL_{(N)}, as shown in FIG. 3, such that the pixel formation portions corresponding to their respective pixels of the same color in even and odd display rows are positioned apart from each other by a distance about one and a half times the center-to-center distance between adjacent pixels in directions along the scanning signal lines (in the figure, horizontally). As a result of such an arrangement, any three adjacent pixels, R, G and B, e.g., pixel formation portions P_{(1,1)}, P_{(1,2)} and P_{(2,1)}, are positioned such that all internal angles of a triangle formed by connecting their centers are acute angles, thereby achieving a delta arrangement.

Furthermore, since the self-source line, which is a video signal line connected to pixel electrodes of pixel formation portions corresponding to their respective pixels of the same color, is the video signal line SL₍ₘ₊₁₎ when the number n corresponding to a display row is odd or the video signal line SL₍ₘ₎ when the number n is even, pixel data for the same color is simply provided to the same video signal line, e.g., blue pixel data to SL₍₁₎ and red pixel data to SL₍₂₎, even if the pixel color varies from one display column to another, resulting in a structure to be readily driven. Also, such a structure eliminates the need to consider the impact of potential fluctuations of the self-source line via the parasitic capacitance Csₐ, because such impact does not appear as horizontal streaks on the display screen. Details will be described later.

The display control circuit 200 receives a display data signal DAT and a timing control signal TS, which are externally transmitted, and outputs digital image signals DV, along with a source start pulse signal SSP, a source clock signal SCK, a latch strobe signal LS, a gate start pulse signal GSP, and a gate clock signal GCK, which are intended to control the timing of displaying an image on the display portion 500.

Here, the external display data signal DAT contains, for example, a total of 24 bits of parallel data consisting of 8-bit display data for each of red, green and blue, each of these colors being provided to one pixel formation portion corresponding to that color. As described above, such data is provided through corresponding video signal lines color by color.

However, the data is corrected to compensate for the impact of potential fluctuations via parasitic capacitance to be described later.

The video signal line drive circuit 300 receives the digital image signals DV, the source start pulse signal SSP, the source clock signal SCK, and the latch strobe signal LS, which are outputted by the display control circuit 200, and applies drive video signals S₍₁₎to S_{(M)}to the video signal lines SL₍₁₎to SL_{(M)}, respectively, in order to store charge in the pixel capacitance Clc (and auxiliary capacitance) of the pixel formation portions P_{(n,m)} in the display portion 500. At this time, the video signal line drive circuit 300 sequentially holds therein the digital image signal DVs, which exhibit voltages to be applied to the video signal lines SL₍₁₎to SL_{(M)}, upon each pulse of the source clock signal SCK. Then, upon each pulse of the latch strobe signal LS, the digital image signals DV being held are converted into analog voltages. The analog voltages are simultaneously applied to all of the video signal lines SL₍₁₎ to SL_{(M)} as drive video signals. Specifically, the present embodiment employs a line-sequential drive system as a system for driving the video signal lines SL₍₁₎to SL_{(M)}. The present embodiment also employs a line inversion drive system, a drive system in which the polarity of a voltage applied to a pixel liquid crystal is reversed for each row in the display portion 500 and also for each frame.

The scanning signal line drive circuit 400 sequentially applies active scanning signals G₍₁₎ to G_{(N)} to the scanning signal lines GL₍₁₎ to GL_{(N)}, based on the gate start pulse signal GSP and the gate clock signal GCK, which are outputted by the display control circuit 200.

The common electrode drive circuit 600 generates a common voltage V_{com}, which is a voltage to be provided to the common electrode for the liquid crystal. To minimize the voltage swing of the video signal lines, the present embodiment is also configured to cause the potential of the common electrode to fluctuate in accordance with inversion drive. Specifically, in response to a polarity inversion signal φ from the display control circuit 200, the common electrode drive circuit 600 generates a voltage to be switched between two reference values every row and every frame, and provides it to the common electrode within the display portion 500 as a common voltage V_{com}. These configurations realize the aforementioned line inversion drive system.

In this manner, the drive video signals are applied to the video signal lines SL₍₁₎ to SL_{(M)} and the scanning signals are applied to the scanning signal lines GL₍₁₎ to GL_{(N)}, so that an image is displayed on the display portion 500.

<2. Configuration and Operation of the Display Control Circuit>

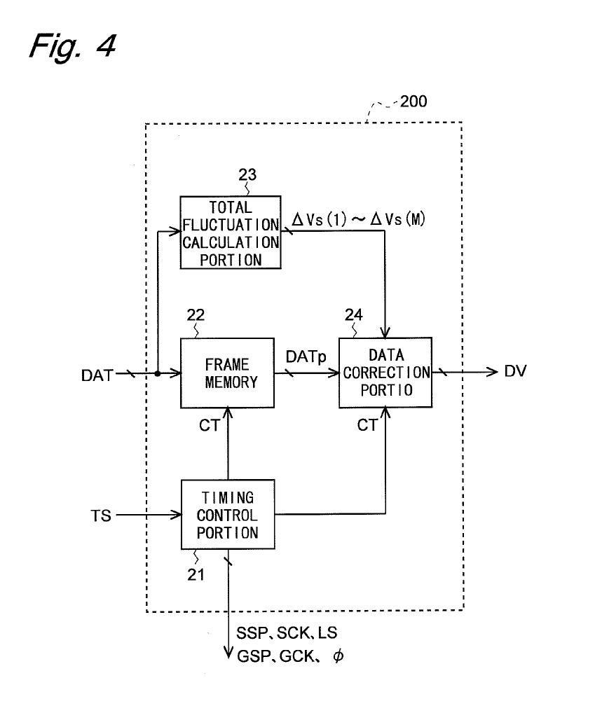

FIG. 4 is a configuration diagram of the display control circuit 200 in the present embodiment. The display control circuit 200 includes a timing control portion 21, frame memory 22, a total fluctuation calculation portion 23, and a data correction portion 24.

The timing control portion 21 receives an externally transmitted timing control signal TS, and outputs a control signal CT for controlling the operation of the frame memory 22 and the data correction portion 24, along with a source start pulse signal SSP, a source clock signal SCK, a latch strobe signal LS, a gate start pulse signal GSP, and a gate clock signal GCK, which are intended to control the timing of displaying an image on the display portion 500.

The frame memory 22 stores an external display data signal DAT for one frame. Also, based on the control signal CT from the timing control portion 21, the frame memory 22 provides the data correction portion 24 with a display data signal DATₚ which corresponds to the next display row of the previous frame with respect to the external display data signal DAT. For example, when display data DAT for the n'th row of the F'th frame (for convenience of explanation) is externally provided, the frame memory 22 provides the data correction portion 24 with display data for the (n+1)'th row of the (F−1)'th frame.

Based on the external display data signal DAT, the total fluctuation calculation portion 23 calculates total amounts of potential fluctuations (hereinafter, referred to as “total fluctuations”) ΔVs₍₁₎ to ΔVs_{(M)} of drive video signals to be applied to the video signal lines SL₍₁₎ to SL_{(M)}within one frame, and provides the calculated values to the data correction portion 24. Specifically, based on externally received display data (e.g., display data for the n'th row of the F'th frame) and previously received display data for the previous horizontal scanning period, i.e., the previous row, (e.g., display data for the (n−1)'th row of the F'th frame), the total fluctuation calculation portion 23 calculates the amount of potential fluctuations for each video signal line where such display data is provided, adds the calculated amount to a total amount of potential fluctuations for each video signal line previously calculated for approximately one frame (e.g., from the (n+1)'th row of the (F−1)'th frame to the (n−1)'th row of the th frame), and provides values obtained through addition to the data correction portion 24 as total fluctuations ΔVs₍₁₎ to ΔVs_{(M)} While the total fluctuations here are simply described as cumulative amounts for convenience of explanation, in practice, it is preferable that the total fluctuations be obtained not by simply adding up the amounts of potential fluctuations, which occur every horizontal scanning period, for each video signal line, but by adding up the amounts of potential fluctuations with weighting through multiplication by a coefficient indicating how much impact the amount of potential fluctuations has on pixel brightness during one frame period.

More concretely, the total fluctuation calculation portion 23 includes a (preset) table (hereinafter, referred to as a “tone voltage table”) indicating the correspondence between tone values (e.g., 0 to 255), which are indicated by display data corresponding to drive video signals to be provided to specific video signal lines, and voltage values for the drive video signals. When a drive video signal corresponding to externally received display data is provided, the total fluctuation calculation portion 23 calculates the amount of potential fluctuations that indicates how the potential of a corresponding video signal line changed from the previous horizontal scanning period, based on the tone voltage table and the polarity inversion signal φ. The amounts of potential fluctuations are cumulatively calculated for one frame as described above and provided to the data correction portion 24 as total fluctuations ΔVs₍₁₎ to ΔVs₍ₘ₎ (e.g., as far as the n'th row of the F'th frame with respect to the potential of the drive video signal that corresponds to display data for the (n+1)'th row of the (F−1)'th frame). Note that the reason for referencing the polarity inversion signal φ is that in some cases, the aforementioned line inversion drive results in the voltage to be applied to the video signal line being changed (in terms of polarity) even if the tone value of the display data remains the same.

For the display data signal DAT (corresponding to the next display row of the previous frame) received from the frame memory 22, the data correction portion 24 calculates a correction value for compensating for the impact of changes of the total fluctuations ΔVs₍₁₎ to ΔVs₍ₘ₎ received from the data correction portion 24 on their corresponding video signal lines via the parasitic capacitance Cs_{b}. More details will be described below.

First, as described earlier with reference to FIG. 2, the potential of a pixel electrode changes via parasitic capacitance Cs_{b} due to potential fluctuations of one of two adjacent video signal lines, i.e., the other (the other-source line) of the two video signal lines adjacent to the pixel electrode that is not connected to that pixel electrode, and the potential of the pixel electrode also changes via parasitic capacitance Csₐ due to potential fluctuations of the video signal line (the self-source line) that is connected to that pixel electrode.

However, particularly in the case of display panels with delta-arrangement structures, only the change in potential of the pixel electrode via the parasitic capacitance Cs_{b} due to the potential fluctuations of the other-source line causes horizontal streaks.

Specifically, even if pixels vary in color from one display column to another, as described above, pixel data for the same color is provided to the same video signal line, and therefore potential fluctuations of pixel electrodes, which occur via the parasitic capacitance Csₐ due to potential fluctuations of the self-source line, are approximately equal within the same display column. Accordingly, the potential fluctuations of the self-source line might cause a deviation from desired brightness as in typical matrix-arrangement display devices but do not result in horizontal streaks. Conversely, to address crosstalk in typical matrix-arrangement display devices, it is insufficient to simply consider potential fluctuations of the other-source lines without taking account of the self-source lines, but in the case of the delta-arrangement color display device of the present embodiment, horizontal streaks can be addressed by simply considering potential fluctuations of the other-source lines, which makes it possible to simplify the feature for correction. Note that the self-source lines may also be taken into consideration.

From the above, if a total amount of potential fluctuations of the other-source line is known for approximately one frame from a completion point of (desired potential) charging of the pixel electrode (and deselection of its corresponding TFT 10) to a start point of the next charging, the total amount is multiplied by a coefficient previously calculated based on the structure of the panel, various parameters, etc., thereby making it possible to readily calculate a correction value for suppressing or eliminating horizontal streaks, the value corresponding to the amount of potential fluctuations of the pixel electrode affected via the parasitic capacitance Cs_{b}.

Therefore, for example, when display data for the n'th row of the F'th frame is externally provided as described above, it is possible to compensate for the impact of potential fluctuations via parasitic capacitance Cs_{b} by adding correction values to display data DAT for the (n+1)'th row of the (F−1)'th frame, the correction values being tone values which correspond to the amounts of potential fluctuations of pixel electrodes obtained by multiplying the total fluctuations ΔVs₍₁₎ to ΔVs_{(M)}, which are total amounts of potential fluctuations of the other-source lines approximately until the previous frame, by those coefficients.

However, unlike typical matrix-arrangement display panels, the display portion 500 of the present embodiment with the delta arrangement as shown in FIG. 3 is structured such that video signal lines to be connected to their respective corresponding pixel electrodes alternatingly change in even and odd display rows. Specifically, as is apparent from FIG. 3, video signal lines adjacent to the right of pixel electrodes in odd rows are self-source lines, and in even rows, video signal lines adjacent to the left of the pixel electrodes are the self-source lines.

Accordingly, the data correction portion 24 calculates correction values for even rows by multiplying total fluctuations which correspond to video signal lines adjacent to the left of pixel formation portions by predetermined coefficients and calculates correction values for odd rows by multiplying total fluctuations which correspond to video signal lines adjacent to the right of the pixel formation portions by predetermined coefficients.

Concretely, in the case where the number n is odd (in the case of an even row), the data correction portion 24 calculates a correction value for compensating for the impact on display data DAT_{p(n+1,m)} for the (n+1)'th row of the (F−1)'th frame that is to be provided to the pixel formation portion P_{(n+1,m)}, by multiplying a total fluctuation ΔVs₍ₘ₎, which corresponds to a left-adjacent video signal line, by a predetermined coefficient. Also, in the case where the number n is even (in the case of an odd row), the correction value is calculated by multiplying a total fluctuation ΔVs₍ₘ₊₁₎, which corresponds to a right-adjacent video signal line, by a predetermined coefficient.

The data correction portion 24 adds the correction values thus calculated to their corresponding display data, i.e., in the above example, the display data DATₚ for the (n+1)'th row of the (F−1)'th frame, and outputs resultant display data compensated for the impact via the parasitic capacitance Cs_{b} as digital image signals DV.

The digital image signals DV are supplied to the video signal line drive circuit 300 where the digital image signals DV are converted into analog voltages for each color before application to their corresponding video signal lines SL₍₁₎ to SL_{(M)} as drive video signals. The voltages thus applied to the video signal lines SL₍₁₎ to SL_{(M)} as the drive video signals are then applied to pixel electrodes Eₚᵢₓ of pixel formation portions P_{(n,m)} via TFTs 10, which have been brought into conductive state through sequential application of active scanning signals by the scanning signal line drive circuit 400, and the applied voltages are held in pixel capacitance Clc of the pixel formation portions P_{(n,m)}. The voltages being held in the pixel capacitance Clc are applied to the liquid crystal to control the light transmittance of the display portion 500, so that an image is displayed with reduced or eliminated horizontal streaks to be caused by the aforementioned potential fluctuations via parasitic capacitance.

<3. Effect>

As described above, according to the present embodiment, to compensate for the impact of potential fluctuations of an other-source line, which is a video signal line adjacent but not connected to a pixel formation portion, the potential fluctuations occurring via parasitic capacitance Cs_{b} between the other-source line and the pixel formation portion, a correction value is calculated by multiplying a total amount of potential fluctuations of a video signal line adjacent to the left of the pixel formation portion by a predetermined coefficient in the case of an even row or it is calculated by multiplying a total amount of potential fluctuations of a video signal line adjacent to the right of the pixel formation portion by a predetermined coefficient in the case of an odd row. As a result, the delta-arrangement color display device in the present embodiment makes it possible to reduce or eliminate horizontal streaks which occur due to the impact of potential fluctuations via parasitic capacitance Cs_{b} as mentioned above, using a simplified configuration without forming any characteristic structure.

<4. Variant>

In the above embodiment, display data for one frame is stored in the frame memory 22 and a correction value is calculated by obtaining a total amount of potential fluctuations resulting from such display data for one frame being provided to video signal lines corresponding thereto, but display data for two frames may be stored in the frame memory 22 and the correction value may be calculated by referencing a portion of the stored display data that corresponds to a frame period from the second preceding frame to the immediately preceding frame (hereinafter, referred to as an “initial frame”) to correct display data for a frame period from the immediately preceding frame to the current time point (hereinafter, referred to as a “subsequent frame”) and obtaining a total amount of potential fluctuations resulting from such corrected display data for the subsequent frame being provided to video signal lines corresponding thereto.

Specifically, in this variant, the total fluctuation calculation portion 23 first reads display data included in the initial frame from the frame memory 22 without receiving external display data, and calculates its corresponding total fluctuation. The data correction portion 24 calculates a correction value based on the calculated total fluctuation corresponding to the initial frame, as described above, and corrects display data for the subsequent frame stored in the frame memory 22 based on the calculated correction value, the data being stored again (rewritten). Subsequently, the total fluctuation calculation portion 23 reads the corrected display data included in the subsequent frame from the frame memory 22, and calculates its corresponding total fluctuation. The data correction portion 24 calculates a correction value based on the calculated total fluctuation corresponding to the subsequent frame, as described above. Consequently, a total amount of potential fluctuations of other-source lines, which is referenced to calculate the correction value, corresponds to a total amount of potential fluctuations which occur when a corrected video signal is provided, and therefore correction value can be calculated more accurately, making it possible to reliably reduce or eliminate horizontal streaks.

Also, in this variant and the above embodiment, the total fluctuation has been described as being preferably added up with weighting considering how much impact the potential fluctuations have on pixel brightness within one frame period, but, for example, the total fluctuation may be simply an amount of potential fluctuations of self-source lines immediately after given pixel formation portions are deselected, considering such potential fluctuations having the most impact on pixel brightness within one frame period, or may be simply a total amount of potential fluctuations within several horizontal scanning periods after the deselection. Specifically, the total fluctuation may be a value indicating the impact of potential fluctuations of other-source lines with reference to a potential of a pixel electrode in any pixel formation portion, the fluctuations being caused during approximately one frame period between a time point immediately after the pixel formation portion was caused to transition from selected to deselected state by driving its corresponding scanning signal line and a time point immediately before the next selected state.

Note that in the above embodiment, the frame memory 22, the total fluctuation calculation portion 23, and the data correction portion 24 are included in the display control circuit 200, but all or part of them may be included in the video signal line drive circuit 300 or may be included in an individual drive control circuit different from those circuits. Also, these functions may be realized by a microcomputer executing programs corresponding thereto.

Also, while the above embodiment has been described by taking as an example the active-matrix color liquid crystal display device, the present invention can be applied to display devices other than liquid crystal display devices so long as the devices are delta-arrangement color display devices based on active-matrix voltage control in which parasitic capacitance is present between pixel electrodes and video signal lines.

### INDUSTRIAL APPLICABILITY

The present invention is applied to color display devices employing delta arrangement, and is suitable for active-matrix color display devices having liquid crystal elements or EL elements arranged therein.

### DESCRIPTION OF THE REFERENCE CHARACTERS

10 TFT (switching element)
21 timing control portion
22 frame memory
23 total fluctuation calculation portion
24 data correction portion
200 display control circuit
300 video signal line drive circuit
400 scanning signal line drive circuit
500 display portion
DAT display data signal (image signal)
DV digital image signal
Clc liquid crystal capacitance (pixel capacitance)
Csₐ, Cs_{b} parasitic capacitance
E_{com} common electrode
Eₚᵢₓ pixel electrode
GL₍ₙ₎ scanning signal line (n=1 to N)
SL₍ₘ₎ data line (m=1 to M)
P_{(n,m) pixel formation portion (n=}1 to N, m=1 to M)

1. A color display device comprising a plurality of video signal lines for transmitting a plurality of video signals corresponding to image signals provided from outside the device for displaying a color image, a plurality of scanning signal lines crossing the video signal lines, a plurality of types of pixel formation portions arranged along the video signal lines and the scanning signal lines for displaying different primary colors, and a drive control circuit for driving the video signal lines and the scanning signal lines, wherein,
the pixel formation portions are disposed in delta arrangement such that the plurality of types are adjacent to each other, and
the drive control circuit corrects a video signal to be provided to any pixel formation portion so as to compensate for impact by potential fluctuations of an opposite video signal line that are caused via parasitic capacitance between the opposite video signal line and said any pixel formation portion, the opposite video signal line being a video signal line adjacent but not connected to said any pixel formation portion.

2. The color display device according to claim 1, wherein the drive control circuit corrects the video signal to be provided to said any pixel formation portion, so as to compensate for only the impact of potential fluctuations of the opposite video signal line.

3. The color display device according to claim 1, wherein the drive control circuit calculates a value indicating impact by potential fluctuations of the opposite video signal line that are caused during approximately one frame period between a time point immediately after said any pixel formation portion was caused to transition from selected to deselected state by driving a scanning signal line corresponding thereto and a time point immediately before the next selected state, and the drive control circuit corrects the video signal based on the calculated value.

4. The color display device according to claim 3, wherein the drive control circuit includes:
a memory for storing values indicating pixel display tones included in the image signals for at least one frame period;
a total fluctuation calculation portion for calculating a total amount of potential fluctuations based on the values stored in the memory or the image signals as a value indicating the impact by the potential fluctuations; and
a data correction portion for correcting a value stored in the memory that indicates a corresponding pixel display tone based on a value obtained by multiplying the total amount calculated by the total fluctuation calculation portion by a predetermined coefficient in accordance with the parasitic capacitance.

5. The color display device according to claim 1, wherein the pixel formation portions each include:
a switching element to be brought into a conductive or closed state in accordance with a signal applied to a scanning signal line connected to the pixel formation portion;
a pixel electrode connected via the switching element to a video signal line connected to the pixel formation portion and having the parasitic capacitance between the pixel electrode and the opposite video signal line;
a common electrode commonly provided for the pixel formation portions;
pixel capacitance formed by the pixel electrode and the common electrode; and
a liquid crystal element for displaying a pixel in a display tone in accordance with a voltage being held in the pixel capacitance.
